(19) United States
(12) Patent Application Publication
(10) Pub. No.: US 2012/0319653 A1
(43) Pub. Date: Dec. 20, 2012

(54) SYSTEM AND METHOD FOR RECHARGEABLE BATTERY

(76) Inventors: Ajith Kuttannair KUMAR, Erie, PA (US); Herman WIEGMAN, Niskayuna, NY (US)

(21) Appl. No.: 13/160,888

(22) Filed: Jun. 15, 2011

(51) Int. Cl. H02J 7/04; H02J 7/00

(52) U.S. Cl. 320/118; 320/119

(57) ABSTRACT

A rechargeable battery has a plurality of cell strings each having a plurality of rechargeable electrochemical cells connected in series, and a plurality of charge regulators each connected in series with one of the cell strings. Each charge regulator is adapted to limit a charge voltage or current applied to the cell string based on a determined top-of-charge voltage for each cell string. In an embodiment, the rechargeable battery has a monitoring system to sense an operating parameter of the cell string and determine the top-of-charge voltage, and each of the charge regulators includes a charge voltage controller in communication with the monitoring system. In another embodiment, the rechargeable battery has discharge regulators each connected in series with one of the cell strings, and adapted to limit a discharge voltage or current from a given cell string based upon at least one monitored parameter of the cell string.

### BACKGROUND

1. Technical Field

The subject matter disclosed herein relates to energy storage devices, and more particularly to rechargeable batteries.

2. Discussion of Art

Rechargeable batteries may have challenges in the charge and discharge operations resulting in undesired battery performance and premature deterioration of the electrochemical cells. In addition, rechargeable batteries having more than one electrochemical cell or parallel arrangement of electrochemical cells may have challenges stemming from variation in the charge and discharge performance of the parallel electrochemical cells. These challenges may affect the efficiency of the charge and discharge operations.

It may be desirable to have a rechargeable battery that differs from those that are currently available.

### BRIEF DESCRIPTION

Presently disclosed is a rechargeable battery having a plurality of cell strings, each cell string having a plurality of rechargeable electrochemical cells connected in series, and a plurality of charge regulators, each charge regulator connected in series with one of the plurality of cell strings, where each charge regulator is adapted to limit at least one of the charge voltage and charge current applied to the cell string based on a determined top-of-charge voltage for each cell string. In an embodiment, the rechargeable battery also has a monitoring system configured to sense at least one operating parameter of the cell string and determine the top-of-charge voltage for the cell string. In one embodiment, each one of the plurality of charge regulators includes a charge voltage controller in communication with the monitoring system configured to limit at least one of the charge voltage and charge current applied to the cell string based on the determined top-of-charge voltage for the cell string determined by the monitoring system.

In another embodiment, the rechargeable battery includes a plurality of cell strings, each cell string having a plurality of rechargeable electrochemical cells connected in series, a plurality of charge regulators, each charge regulator connected in series with one of the plurality of cell strings, where each charge regulator is adapted to limit at least one of a charge voltage or a charge current applied to the cell string based on a determined top-of-charge voltage for each cell string, and a plurality of discharge regulators, each discharge regulator connected in series with one of the plurality of cell strings, where each discharge regulator is adapted to limit at least one of a discharge voltage or a discharge current from a given cell string based upon at least one monitored parameter of the cell string. In one embodiment, the plurality of discharge regulators cooperate to apply a substantially uniform output voltage to a load.

In another embodiment, a rechargeable battery has a plurality of cell strings, each cell string having a plurality of rechargeable electrochemical cells connected in series; and each cell string has a respective charge regulator connected in series with the cell string, wherein the charge regulator is adapted to limit at least one of a charge voltage or a charge current applied to the cell string based on at least one first monitored parameter of the cell string; and each cell string also has a respective discharge regulator connected in series with the cell string, wherein the discharge regulator is adapted to limit at least one of a discharge voltage or a discharge current front the cell string based on the at least one first monitored parameter of the cell string or at least one second monitored parameter of the cell string.

Also disclosed is a method of operating a rechargeable battery system. The method includes determining a top-of-charge voltage for each of a plurality of cell strings of a rechargeable battery, each cell string having a plurality of electrochemical cells and a charge regulator and a discharge regulator in series with the electrochemical cells, wherein the top-of-charge voltage is determined based on at least one first monitored parameter of the cell string. The method also includes operating the charge regulator of each cell string to limit at least one of a charge voltage or a charge current applied to the cell string based on the determined top-of-charge voltage for the cell string; and operating the discharge regulator of each cell string to limit at least one of a discharge voltage or a discharge current from the cell string based upon the at least one first monitored parameter of the cell string or based upon at least one second monitored parameter of the cell string. In one embodiment, the discharge regulators cooperate to supply a substantially uniform output voltage to a load.

### BRIEF DESCRIPTION OF THE DRAWINGS

Reference is made to the accompanying drawings in which particular embodiments and further benefits of the invention are illustrated as described in more detail in the description below, in which:

FIG. 1 is a schematic view of a first embodiment of a rechargeable battery system;

FIG. 2 is a schematic view of a second embodiment of a rechargeable battery system;

FIG. 3 is a schematic view of a third embodiment of a rechargeable battery system;

FIG. 4; is a schematic view of a fourth embodiment of a rechargeable battery system;

FIG. 5 is a graph illustrating determined top-of-charge voltage per cell;

FIG. 6 is a graph illustrating determined top-of-charge voltage for a cell string;

FIG. 7 illustrates the current/voltage operating region for a charge regulator and a discharge regulator;

FIG. 8 is a block diagram of cell string with current monitoring;

FIG. 9 is a graph illustrating desired charging current as a function of string voltage;

FIG. 10 is a block diagram of a cell string with voltage monitoring; and

FIG. 11 is a graph illustrating state of charge of a rechargeable while charging.

### DETAILED DESCRIPTION

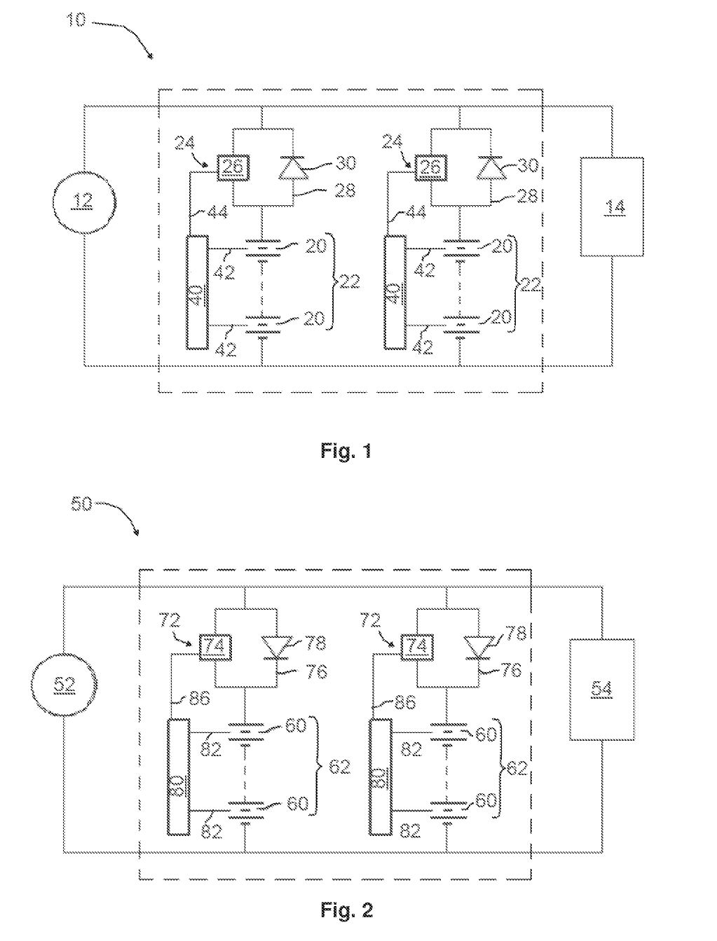

The subject matter disclosed herein relates to a rechargeable battery system and method of operating a rechargeable battery system. Referring generally to FIGS. 1 through 11, embodiments of a rechargeable battery system and method of operating a rechargeable battery system are disclosed.

Referring to FIG. 1, a first embodiment of a rechargeable battery system has a rechargeable battery 10 connected between a source 12 and a load 14. The source 12 may be a variety of electrical power generation devices or systems. In one embodiment, the source 12 is a regenerative brake system of a vehicle, such as an automobile or train. In another embodiment, the source 12 is an internal combustion engine in combination with a generator or alternator configured to produce electrical power. In yet another embodiment, the source 12 is an electricity distribution system, such as a national power grid, electric utility or other commercially available electrical supply. In various embodiments, the source 12 may include one or more different sources of electrical power. The source 12 supplies electrical power to the rechargeable battery 10 to recharge or maintain the charge level of the rechargeable battery 10. In addition, the source 12 may supply electrical power directly to the load 14. In some applications, the output of the source 12 may be controlled through the use of voltage regulators, current regulators, or other devices to provide the desired input voltage and current to the rechargeable battery 10 and/or the load 14. The rechargeable battery 10 also supplies electrical power to the load 14, alternately or in combination with the source 12.

In various embodiments, the load 14 includes an electric motor for use with vehicles, such as automobiles or trains, and may include peripheral electrical devices such as lights, audio equipment, heaters, air conditioners or other devices for the vehicles. In other embodiments, the load 14 includes computing equipment, such as network servers, or telecommunications equipment, such as cell phone base stations, and may include environmental control equipment, such as, HVAC systems for heating and/or cooling equipment as needed. In yet another embodiment, the load 14 includes medical equipment requiring a stable input power source provided by the combination of the source 12 and the rechargeable battery 10. In some applications, a variety of loads 14 are connected to one or more rechargeable batteries 10. In various embodiments, the rechargeable battery 10 operates as a backup or redundant electrical supply, such as an uninterruptible power supply, to provide electrical power to a load 14 during interruptions in the availability of a primary energy source. In an embodiment, the power consumption of the load 14 is controllable, so that the power consumption is reduced based upon the power available from the rechargeable battery 10 when the primary energy source is unavailable. In another embodiment, the rechargeable battery 10 stores sufficient power to allow the load 14 to perform a controlled shutdown upon failure of a primary power source. In other embodiments, the rechargeable battery 10 stores sufficient power to operate the load until the primary power source can be restored or a backup power source, such as a generator can be connected and made operational. Additional circuitry, such as fuses and circuit breakers (not shown), are also utilized, as necessary for any given application.

As illustrated in FIG. 1, the rechargeable battery 10 includes a plurality of electrochemical cells 20 connected in series forming a cell string 22. The plurality of electrochemical cells 20 configured in a cell string 22 enables the rechargeable battery to provide an output voltage greater than that possible with a single electrochemical cell. In different embodiments, the rechargeable battery 10 may have at least 100, at least 200, or at least 400 rechargeable electrochemical cells 20 in series. In other embodiments, the rechargeable battery 10 includes a plurality of cell strings 22 connected in parallel. The plurality of cell strings 22 provides greater energy storage capacity for the rechargeable battery 10 and may allow a larger power output to be provided to a load 14. In one embodiment, the electrochemical cells 20 are sodium-metal-halide cells. In other embodiments, the electrochemical cells 20 may be sodium-halide, sodium-sulfur, lithium-sulfur or other rechargeable electrochemical cells used for energy storage. In addition, one or more types of electrochemical cells may be used as appropriate for a given application. In one embodiment, the electrochemical cells have an operating temperature determined by the melting point of the material utilized in the cells. For example, the operating temperature may be greater than 100 degrees Celsius, such as between 250 degrees Celsius and 400 degrees Celsius, or between 400 degrees Celsius and 700 degrees Celsius, but other operating temperatures are possible.

The rechargeable battery 10 also includes a plurality of charge regulators 24, with each charge regulator 24 connected in series with one of the plurality of cell strings 22. In an embodiment, the charge regulators each include a charge voltage controller 26 configured to limit at least one of a charge voltage or a charge current applied to the cell string based on a determined top-of-charge for the cell string 22. In one embodiment, the rechargeable battery 10 also includes a monitoring system 40 configured to sense at least one operating parameter of the cell string 22 and determine a top-of-charge voltage for the cell string. The monitoring system 40 communicates with the charge regulator 24 to control the charge operation. In an embodiment, the charge voltage controller 26 is in communication with the monitoring system to control the charging operation for the given cell string.

During operation of the rechargeable battery 10, the plurality of charge regulators 24 control the charging of each cell string based on the determined top-of-charge for the particular cell string. This allows for variation in the determined top-of-charge between different cell strings 22 and improves the operation of the rechargeable battery system. As discussed below, other embodiments of a rechargeable battery include a plurality of discharge regulators, with each discharge regulator connected in series with one of the plurality of cell strings. The discharge regulators each are configured to limit at least one of a discharge voltage and discharge current from a given cell string. In an embodiment, the discharge regulators cooperate to supply a desired output voltage and current to a load connected to the rechargeable battery. In another embodiment, the discharge regulators limit the extent to which a cell string is discharged to avoid damage to the electrochemical cells that may result from being overly depleted. In yet another embodiment, the discharge regulators limit the discharge voltage and current of a given cell string based upon the state of charge of the cell string. In the rechargeable battery presently disclosed, each cell string may be controlled during both the charge and discharge operations as desired to improve the performance of the rechargeable battery over prior art designs.

As illustrated in FIG. 1, the rechargeable battery 10 includes a monitoring system 40. The monitoring system 40 is configured to sense at least one operating parameter of the cell string 22. In one embodiment, the monitoring system 40 includes a voltage detector configured to measure a cell string voltage, which is the voltage across the plurality of electrochemical cells 20 of the cell string 22. In another embodiment, the monitoring system 40 includes a current detector configured to measure a cell string current, which is the current flowing through the cell string 22. In other embodiments, the monitoring system 40 may include combinations of voltage and current detectors. In yet another embodiment, the monitoring system 40 includes a temperature sensor configured to measure the temperature of the rechargeable battery 10, the cell string 22, the electrochemical cells 20 of a cell string 22, or combinations thereof. In yet another embodiment, the monitored operating parameters include the actual or expected duration of chame or discharge operations. In another embodiment, the operating parameter sensed by the monitoring system 40 is a health status of one or more of the electrochemical cells 20, such as the cell chemistry, the age of the electrochemical cell, and the number of charge/discharge cycles performed. Alternatively or in addition, the operating parameter sensed by the monitoring system 40 includes the state of charge of the electrochemical cells 20, either individually or in combination as the state of charge of the cell string. In various embodiments, the monitoring system 40 is further configured to measure one or more operating parameters during charge or discharge operations, or When a cell string 22 of the rechargeable battery 10 is not being charged or discharged by the system. The monitoring system 40 uses one or more of the operating parameters of the electrochemical cells to determine a top-of-charge voltage for the cell string, where the top-of-charge voltage is the desired voltage across the cell string when in a fully charged state.

In one embodiment, the monitoring system 40 is configured to detect failed electrochemical cells in a cell string. In an embodiment, a failed electrochemical cell is defined as forming a substantially short circuit, such that the electrochemical cell conducts current with a voltage drop across the electrochemical cell of less than a determined amount, such as, less than 1.0 volt, less than 0.5 volt, or less than 0.1 volt. In another embodiment, a failed electrochemical cell is defined as forming a substantially short circuit, where the electrochemical cell retains less than a determined percentage of the original enemy storage capacity of the electrochemical cell, such as, less than 20%, less than 10% or less than 5%. In yet another embodiment, a failed electrochemical cell is defined as forming a substantially short circuit, where the electrochemical cell presents a low resistance between an anode and cathode of the electrochemical, such as less than 100 ohms, less than 25 ohms, or less than 10 ohms. A rechargeable battery 10 having one or more failed electrochemical cells 20 that form a substantially short circuit may remain operational. In one embodiment, the rechargeable battery 10 remains operational but with the maximum output voltage or current reduced due to the failed electrochemical cells. In another embodiment, the determined top-of-charge voltage for a cell string is reduced based upon the number of failed electrochemical cells identified in a cell string of the rechargeable battery. In yet another embodiment, the monitoring system 40 is configured to measure reductions in energy storage capacity of the electrochemical cells resulting from age or other factors, and the top-of-charge voltage thr the cell string is determined based on this measured degradation of the electrochemical cells.

In some embodiments, the monitoring system 40 of the rechargeable battery 10 receives a cell monitoring signal 42 corresponding to the at least one monitored parameter of one or more of the electrochemical cells 20, in one example, the cell monitoring signal 42 corresponds to the voltage drop across one or more of the monitored electrochemical cells during operation of the battery. In another example, the cell monitoring signal 42 corresponds to the current flow through one or more of the electrochemical cells. In yet another embodiment, the cell monitoring signal 42 corresponds to the temperature of one or more of the monitored electrochemical cells. In yet another embodiment, the cell monitoring signal 42 corresponds to the state of charge of a particular electrochemical cell 20 or of the cell string 22, where the state of charge represents the energy stored in the electrochemical cells.

As further illustrated in FIG. 1, the rechargeable battery 10 includes a charge voltage controller 26 connected in series with the electrochemical cells 20 forming the cell string 22. The charge voltage controller 26 receives input voltage and current from the source 12 and applies a charge voltage and charge current to the electrochemical cells 20 of the cell string 22. The charge voltage controller 26 is configured to limit at least one of the charge voltage and charge current applied to the cell string 22 based on a determined top-of charge voltage for each cell string. In another embodiment, the charge voltage controller 26 is also configured to limit the charge voltage applied to the cell string based on detected failed electrochemical cells 20 of the cell string.

In this manner, the charge regulator 24 avoids overcharging the cell string by limiting at least one of the charge voltage or charge current applied to the cell string during a recharge operation. In one embodiment, the charge voltage applied to the cell string is limited when the monitored state of charge of the cell string is within 10% of the determined top-of-charge voltage for the cell string. In another example, the charge voltage applied to the cell string is limited when the monitored state of charge of the cell string is within 5%, or within 1% of the determined top-of-charge voltage for the cell string. In yet another embodiment, the charge regulator 24 progressively limits the charge voltage applied to the cell string as the state of charge of the cell string approaches the determined top-of-charge voltage for the cell string. The charge regulator 24 may reduce the chare voltage in discrete steps, linearly, exponentially, or otherwise as desired to achieve a progressive or gradual limiting of the charge voltage during the charge operation. In other embodiments, the charge regulator 24 limits the charge current applied to the cell string based upon one or more of the monitored parameters as described above with respect to the charge voltage. In yet other embodiments, the charge regulator 24 is adapted to regulate the voltage and current applied to the cell string during the charging operation reducing or eliminating the need for precise control of the energy supplied by the source 12 in a rechargeable battery system.

The monitoring system 40 and the charge regulator 24 operate in combination to manage the recharge operation and control the charge voltage or the charge current applied to the electrochemical cells in the cell string. In one example, the monitoring system 40 receives a cell monitoring signal 42 from the plurality of electrochemical cells. Based on the plurality of cell monitoring signals 42, the monitoring system 40 provides a charge regulator control signal 44 to the charge voltage controller 26. Based on the charge regulator control signal 44, the charge voltage controller 26 limits the charge voltage from the source 12 applied to the cell string 22 of the rechargeable battery 10. In some embodiments, the monitoring system 40 communicates with the charge regulator 24 through the charge regulator control signal 44. In one embodiment, the rechargeable battery 10 includes a control system, such as a proportional integral controller, capable of receiving the monitored operating parameters and providing the charge regulator control signal 44 to the charge regulator 24. In other embodiments, the rechargeable battery 10 may include a programmable controller or software implemented controls to produce a desired charge regulator control signal 46.

As illustrated in FIG. 1, the rechargeable battery 10 also includes a plurality of discharge paths 28 in parallel with the charge regulators 24. In one embodiment, the charge voltage controller 26 and the discharge path 28 are provided in a integrated component. The discharge paths 28 are configured to pass discharge current from a given cell string to the load 14. In one embodiment, the discharge path 28 includes a discharge path diode 30. The discharge path diode 30 is configured to substantially block charging current from flowing through the discharge path into the cell string, and is configured to pass discharge current from the cell string 22 to the load 14. By connecting the discharge path diode 30 in parallel with the charge voltage controller 26, the rechargeable battery is capable of switching from a charging state to a discharging state with minimal delay. In some embodiments, rapid transition from charge to discharge is necessary to maintain power to a load, such as when the rechargeable battery 10 is configured as part of an uninterruptible power supply.

Referring now to FIG. 2, a second embodiment of a rechargeable battery system has a rechargeable battery 50 connected between a source 52 and a load 54. The rechargeable battery 50 has a plurality of cell strings 62, each cell string 62 haying a plurality of electrochemical cells 60 connected in series. The rechargeable battery 50 also includes a plurality of discharge regulators 72, with each discharge regulator 72 connected in series with one of the plurality of cell strings 62. Each of the discharge regulators 72 are configured to limit at least one of a discharge voltage and discharge current from a given cell string 62. In one embodiment, the discharge regulators 72 limit the discharge current of a cell string 62 based on the state of charge of the cell string. The discharge regulators 72 are further configured to limit the discharge voltage and discharge current from a given cell string 62 to apply a substantially uniform output voltage to the load 54. In an embodiment, a substantially uniform output voltage is achieved when each cell string is controlled to provide a voltage output within 10%, within 5%, or within 1% of a desired output voltage for the rechargeable battery. In one embodiment, the load 54 requires a voltage or current input less than the maximum discharge voltage and discharge current capable of being supplied by each of the plurality of cell strings 62. As the electrochemical cells 60 age, the discharge voltage and current of the cell strings 64 may become different. Also, changes in the health or operating condition of the electrochemical cells 60 in the cell strings 62 may result in variation in the discharge voltage and current between the cell strings 62 of the rechargeable battery 50. For example, one cell string 62 containing one or more failed electrochemical cells 60 would have a discharge voltage less than other cell strings with a full complement of functional electrochemical cells 60. The discharge regulators 72 of the rechargeable battery operate to limit or adjust the discharge voltage or current from each cell string 62, so that the output voltage of the rechargeable battery 50 is regulated to accommodate for variation between the cell strings 62. In an embodiment, the discharge regulators 72 operate to selectively discharge the cell strings 62 based on the state of charge of each cell string. In one embodiment, cell strings 62 having a greater state of charge are connected to the load and at least partially discharged before other cell strings 62 having a lesser state of charge.

In one embodiment, the discharge regulators 72 are also configured to limit at least one of a discharge voltage or a discharge current from a given cell string 62 based upon at least one monitored parameter of the cell string 62. In another embodiment, the discharge regulators 72 are configured to disconnect a given cell string 62 from the load 54 based upon at least one monitored parameter of the cell string. For example, a discharge regulator 72 may disconnect a cell string 62 when that cell string 62 is depleted or is no longer capable of supplying the output voltage required by the load 54. In this manner, individual cell strings 62 can be connected or disconnected as desired to maintain the desired output voltage and current for a specific application.

As illustrated, the rechargeable battery 50 also includes a monitoring system 80 configured to sense at least one operating parameter of the cell string 62. Additionally, each discharge regulator 72 has a discharge voltage controller 74 in communication with the monitoring system 80 configured to limit at least one of the discharge voltage and discharge current from a given cell string 62 based on at least one monitored operating parameter of the cell string 62. As discussed above in regard to charging operations, the operating parameters that may be monitored and used to regulate the discharge operation include the cell string voltage, cell string current, and combinations of the cell string voltage and current. Additionally, the monitored operating parameters may include the state of charge of the electrochemical cells, the number of failed or degraded electrochemical cells, and temperature of the electrochemical cells. The monitored operating parameters may also include the expected and actual duration of charge and discharge operations experienced by the rechargeable battery 50. In other embodiments, operating parameters of the load 54 are also used to regulate the discharge voltage and current from the cell strings 62. In one embodiment, monitoring system 80 receives one or more cell monitoring signals 82 corresponding to monitored parameters of the electrochemical cells. The cell monitoring signals 82 may also correspond to monitored characteristics of the cell string 62. The monitoring system 80 may communicate with the discharge regulator 72 or discharge voltage controller 74 through a discharge regulator control signal 86. In some embodiments, the rechargeable battery 50 includes a control system, such as a proportional-integral controller or proportional-integral-derivative, capable of receiving the monitored operating parameters and providing the discharge regulator control signal 86 to the discharge regulator 72. In other embodiments, the rechargeable battery 50 may include a programmable logic controller or software implemented controls to produce the discharge regulator control signal 86.

The rechargeable battery 50 also includes a plurality of charge paths 76 in parallel with the discharge regulators 72. In one embodiment, the discharge voltage controller 74 and the charge path 76 are provided in an integrated component. The charge paths 76 are configured to pass charge current from the source 52 to the electrochemical cells 60 of a given cell string 62. In one embodiment, the charge path 76 includes a charge path diode 78. The charge path diode 78 is configured to pass charge current from the source 54 to the electrochemical cells 60 of the cell string 62, while substantially blocking discharge current from flowing through the charge path so that discharge current flows through the discharge voltage controller 74 to be regulated before reaching the load 54. By connecting the charge path diode 78 in parallel with the discharge voltage controller 74, the rechargeable battery is capable of switching from a discharging state to a charging state with minimal delay.

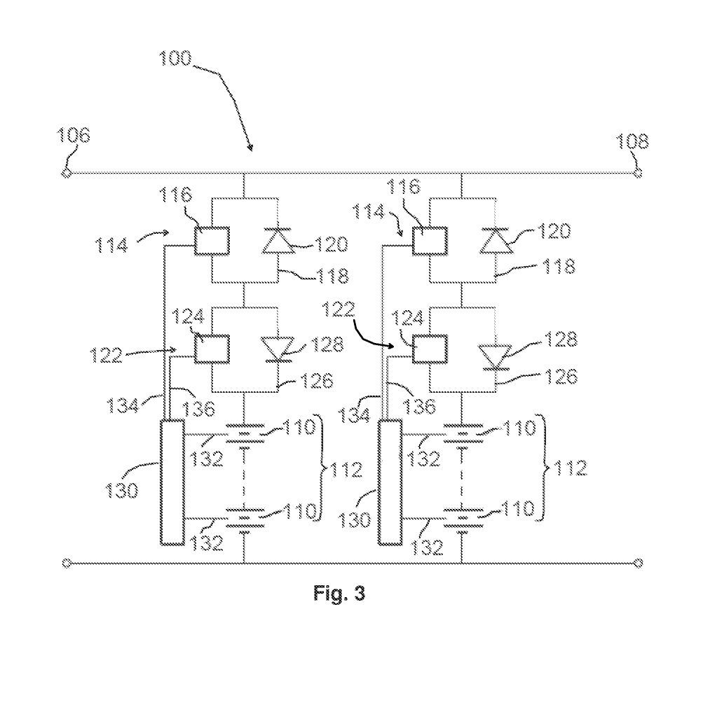

Referring now to FIG. 3, a third embodiment of a rechargeable battery system is illustrated having a rechargeable battery 100 that can be used with a variety of sources and loads, connected through the source connector 106 and load connector 108 respectively. The rechargeable battery 100 has a plurality of cell strings 112, each having a plurality of electrochemical cells 110 connected in series. The rechargeable battery 100 also has both a charge regulator 114 and a discharge regulator 122 in series with each of the cell strings 112. The charge regulators 114 and discharge regulators 122 operate as previously described to control the charge and discharge operation of each cell string 112 of the rechargeable battery 100 and accommodate variation between the cell strings due to differences in performance resulting from age, temperature, failure of electrochemical cells or other factors.

As shown, charge regulator 114 includes a charge voltage controller 116 in parallel with discharge path 118, including discharge path diode 120. Discharge regulator 122 includes discharge voltage controller 124 in parallel with charge path 126, including charge path diode 128. During charging operations, charge current flows from a source through charge path 126 and charge path diode 128, and is regulated by the charge voltage controller 116. In one embodiment, discharge voltage controller 124 is maintained in a conductive state during charging operations. By maintaining discharge voltage controller 124 in a conductive state, the rechargeable battery 100 is able to rapidly transition from charge operations to discharge operations upon interruption of the source and maintain continuous power to the load. In other embodiments, the discharge voltage controller 124 is maintained in a substantially non-conductive state during charge operations, such as in applications where a rapid transition from charge to discharge is not desired. During discharge operations, discharge current flows from the electrochemical cells 110 through discharge path 118 and discharge path diode 120, and is regulated by discharge voltage controller 124. In one embodiment, charge voltage controller 116 is maintained in a conductive state during discharge operations to enable a rapid transition from discharge to charge operations. In another embodiment, charge voltage controller 116 is maintained in a substantially non-conductive state so that upon resuming charge operations the electrochemical cells are not over charged.

The rechargeable battery 100 also includes monitoring system 130 configured to sense at least one operating parameter of the cell string. The monitoring system 130 is also configured to determine a top-of-charge voltage for each of the cell strings. In one embodiment, the rechargeable battery 100 has one monitoring system 130 operably connected to each cell string 112. In another embodiment, one monitoring system 130 may be adapted to monitor a plurality of cell strings 112. A rechargeable battery 100 may thus have one or more monitoring systems 130 operably connected to the plurality of cell strings 112. The monitoring system 130 receives one or more cell monitoring signals 132 corresponding to one or more monitored operating parameters of the electrochemical cells 110 of the cell strings 112. In one embodiment, monitoring system 130 communicates with charge voltage controller 116 through charge regulator control signal 134 and communicates with discharge voltage controller 124 through discharge regulator control signal 136. The monitoring system 130 thus cooperates with the charge regulator 114 and discharge regulator 122 to control the charge and discharge operations of each cell string 112 of the rechargeable battery 100.

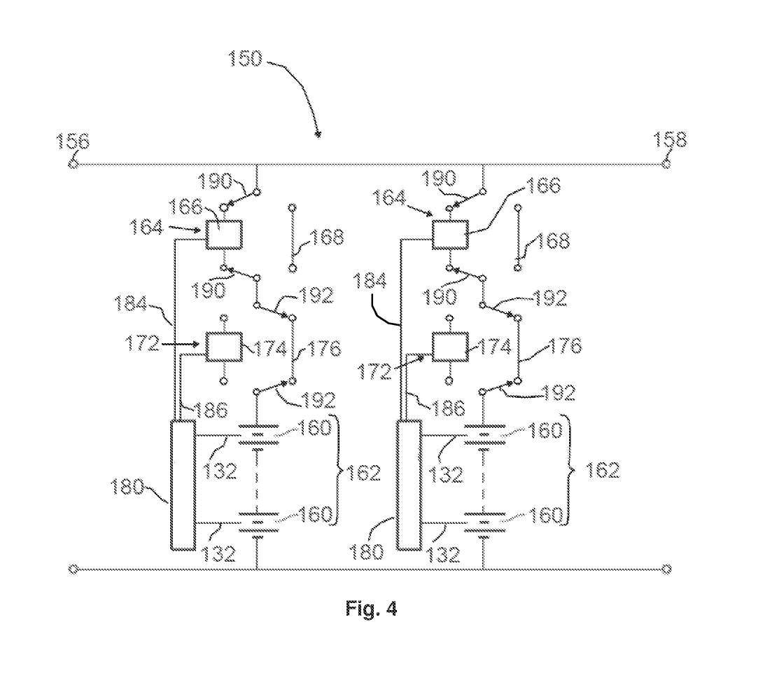

Referring now to FIG. 4, a fourth embodiment of a rechargeable battery system is shown including rechargeable battery 150 having source connector 156 and load connector 158. The rechargeable battery 150 has a plurality of cell string 162, each having a plurality of electrochemical cells 160, and a charge regulator 164 and a discharge regulator 172 in series with each of the cell strings 162. The rechargeable battery 150 includes first switch 190 operable to connect either charge voltage controller 166 or discharge path 168. The rechargeable battery 150 also includes second switch 192 operable to connect either discharge voltage controller 174 or charge path 176. During charge operations, charge voltage controller 166 and charge path 176 are connected in series with the cell string 162 through operation of first switch 190 and second switch 192 respectively, as shown in FIG. 4. During discharge operations, discharge voltage controller 174 and discharge path 168 are connected in series with the cell string 162 through operation of second switch 192 and first switch 190 respectively. In one embodiment, first switch 190 and second switch 192 obviate the need for a directional element, such as a diode, in the charge path and discharge path. As such, in one embodiment, discharge path 168 and charge path 176 are each a shunt or substantially short circuit selectively connected by first switch 190 and second switch 192 during charge and discharge operations.

In multiple embodiments, the rechargeable battery presently disclosed can be used with a source providing a fixed or loosely regulated output voltage. The source output voltage is limited or regulated as appropriate for each of the cell strings by the charge regulators of the rechargeable battery. By actively controlling the recharge operation independently for each cell string, overcharging of the electrochemical cells of the cell strings can be avoided or reduced, Similarly, by controlling the discharge operation for each cell string, variation between cell strings can be accommodated and over discharging of the electrochemical cells can be avoided. The lifespan of the electrochemical cells in each cell string may thus be extended and maintenance or replacement costs for the rechargeable battery may be reduced.

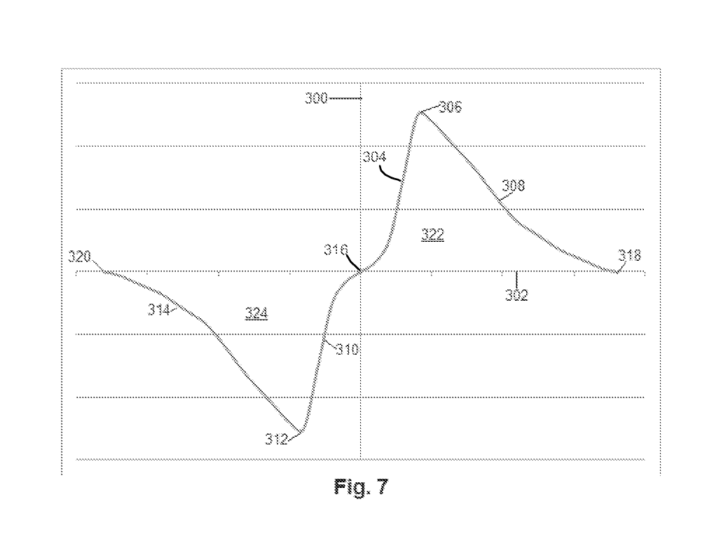

Referring now to FIG. 7, the operation of the charge regulator and discharge regulator of the rechargeable battery are further illustrated. In one embodiment, the charge regulator includes a transistor, such as a field effect transistor or a bi-polar transistor. In another embodiment, the transistor is an insulated-gate bipolar transistor. The charge regulator including a transistor is used to limit the charge voltage or charge current applied to the electrochemical cells in the cell string and to limit the current flow into the cell string during charging operations. For example, when the state of charge of the electrochemical cells is low, such as less than 90% of the desired energy storage capacity, the transistor is operated so as to pass a maximum amount of current to rapidly recharge the electrochemical cells. As the electrochemical cells approach the determined top-of charge voltage, the charge regulator operates the transistor in an active or linear region. Operating the transistor in the active or linear region limits the charge voltage applied to the cell string by varying the resistance presented by the transistor and the voltage drop across the transistor. Additionally, the charging current flowing into the cell string is limited so as to avoid over charging of the electrochemical cells. In this manner, the rate of charge is reduced as the state of charge of the electrochemical cells approaches the determined top-of-charge for the given cell string.

Referring to FIG. 7, the operation of charge regulator including a transistor is illustrated. In FIG. 7, the current flow into a cell string is shown on Y-axis 300 and the voltage drop across the charge regulator or discharge regulator transistors is shown on X-axis 302. Charge operations are conducted in charge region 322 where voltage and current are both positive, while discharge operations are conducted in region 324 where voltage and current are negative. Point 316 represents zero current and zero voltage indicating an off state, neither charging nor discharging. Referring to charge region 322, the charge regulator transistor is generally operable in either a saturated, active or off state based upon a control input, which is typically a voltage. In the saturated state, the transistor exhibits low resistance and conducts current with minimal voltage drop across the transistor. In one example, the voltage drop across a transistor operating in the saturated region is typically between 2 to 4 volts or less. As the charge current increases along line 304 the power dissipation of the transistor increases to a design maximum designated by point 306. In one embodiment, the rechargeable battery includes a cooling system to accommodate the maximum power dissipated by the transistor operating at point 306. When the charge current or charge voltage for a cell string are to be limited, the charge regulator transistor is operated in the active region bounded by line 308. The control input to the transistor is operated to increase the resistance presented by the transistor and increase the voltage drop across the transistor. As the resistance of the transistor increases, the current flow into the cell string will decrease as shown. In one embodiment, the current through the transistor and voltage drop across the transistor are controlled so as not to exceed the maximum power dissipation of point 306. In this manner, a cooling system of the rechargeable battery may be sized to accommodate the heat generated throughout the operating range of the charge regulator. The charge regulator transistor is operated in the active region to limit the charge voltage and charge current applied to the electrochemical cells of a cell string. The charge voltage presented to the cell string is thus the output voltage of the source less the voltage drop across the charge regulator. As the voltage drop across the charge regulator increases, the charge voltage applied to the cell string decreases accordingly. The charge current flowing into the cell string will depend on the output voltage of the source, the state of charge of the electrochemical cells, the internal resistance of the electrochemical cells and the resistance inserted by the charge regulator. As the cell string approaches the determined top-of-charge voltage, the transistor is operated to further limit the current flow into the cell string. Once the cell string reaches the determined top-of-charge voltage, the charging operation is discontinued by controlling the transistor to an off state. In the off state, the transistor presents a high resistance forming a substantially open circuit that does not conduct current, except for unavoidable leakage currents that may be present in the system. The voltage across the transistor at point 318 will be the output voltage of the source less the voltage across the fully charged cell string.

In another embodiment, the charge regulator transistors are operated to remove ripple or other variation from the source output voltage to provide a constant charge voltage to the cell strings. In this embodiment, the charge regulator transistors may be operated in the active region and the resistance of the transistor successively increased and decreased to counter the variation in source output voltage.

In another embodiment, as the state of charge approaches the determined top-of-charge, the charge regulator limits the rate of charge such that a nominal charging current or trickle charge is used to complete the charging of the electrochemical cells. Once the electrochemical cells are determined to be fully charged, the charge regulator transistor is switched to the off or non-conductive state and the charging operation for the cell string is completed. The charge regulator may thus limit the charge voltage applied to the cell string when the state of charge is within 10%, within 5%, or within 1%, of the determined top-of-charge voltage for the cell string. In other embodiments, the charge regulator progressively limits the charge voltage applied to the cell string as the state of charge of the cell string approaches the determined top-of-charge voltage for the cell string. In one embedment, the progressive limiting of the charge voltage may be substantially continuous from a maximum and a minimum charge voltage. In an alternative embodiment, the progressive limiting of the charge voltage occurs in discrete steps. In yet another alternative, the charge voltage is progressively limited from a maximum charge voltage to a trickle charge as the state of charge of the electrochemical cells approaches the determined top-of-charge voltage. In some embodiments, the charge regulator includes multiple transistors connected in parallel to increase the current capacity of the charge regulator. Based on the state of charge of the electrochemical cells, the charge regulator in cooperation with the monitoring system of the rechargeable battery dynamically controls the charge voltage applied to the electrochemical cells. The control of the charge voltage applied to the electrochemical cells results in smooth transitions and avoids overcharging of the electrochemical cells, particularly in cell strings containing one or more failed or degraded electrochemical cells. In this manner, a rechargeable battery system is capable of continued operation even with one or more failed electrochemical cells, while the remaining electrochemical cells are protected from overcharging.

Referring to discharge region 324 in FIG. 7, the discharge operation is substantially similar to the charge operation previously discussed. The discharge regulator transistor is generally operable in either a saturated, active or off state based upon a control input. In the saturated state, the transistor exhibits low resistance and conducts discharge current with minimal voltage drop across the transistor. As the discharge current increases along line 310 the power dissipation of the transistor increases to a design maximum designated by point 312. In one embodiment, the maximum charge power dissipation and maximum discharge power dissipation are designed to be equal, however, in other embodiments, the maximum power dissipated in charge and discharge operations are not equal. The rechargeable battery may include a cooling system sized to accommodate the maximum power dissipated during either the charge or discharge operations. When the discharge current or discharge voltage for a cell string is to be limited, the discharge regulator transistor is operated in the active region bounded by line 314. The control input to the transistor is operated to increase the resistance presented by the transistor and increase the voltage drop across the transistor. As the resistance of the transistor increases, the current flow out of the cell string will decrease as shown. In one embodiment, the current through the transistor and voltage drop across the transistor are controlled so as not to exceed the maximum power dissipation of point 312. The transistor is operated in the active region to limit the discharge voltage and discharge current applied to a load from the electrochemical cells of the cell string. The plurality of discharge regulator transistor are operated to provide a substantially uniform output voltage to a load from the rechargeable battery by accounting for variation between cell strings due to age or other factors. The output voltage presented to the load is thus the voltage across the cell string less the voltage drop across the discharge regulator transistor. As the voltage drop across the discharge regulator increases, the output voltage applied to the load decreases accordingly. The discharge current flowing out of the cell string will depend on the resistance of the load, the state of charge of the electrochemical cells, the internal resistance of the electrochemical cells and the resistance inserted by the discharge regulator. As the cell string approaches a minimum state of charge or if the cell string is unable to supply the desired output voltage, the discharge regulator transistor is controlled to an off state to discontinue the discharge operation. In the off state, the transistor presents a high resistance forming a substantially open circuit that does not conduct current, except for unavoidable leakage currents that may be present in the system. The voltage across the transistor at point 320 will be the output voltage of the rechargeable battery less the voltage across the depleted or discharged cell string.

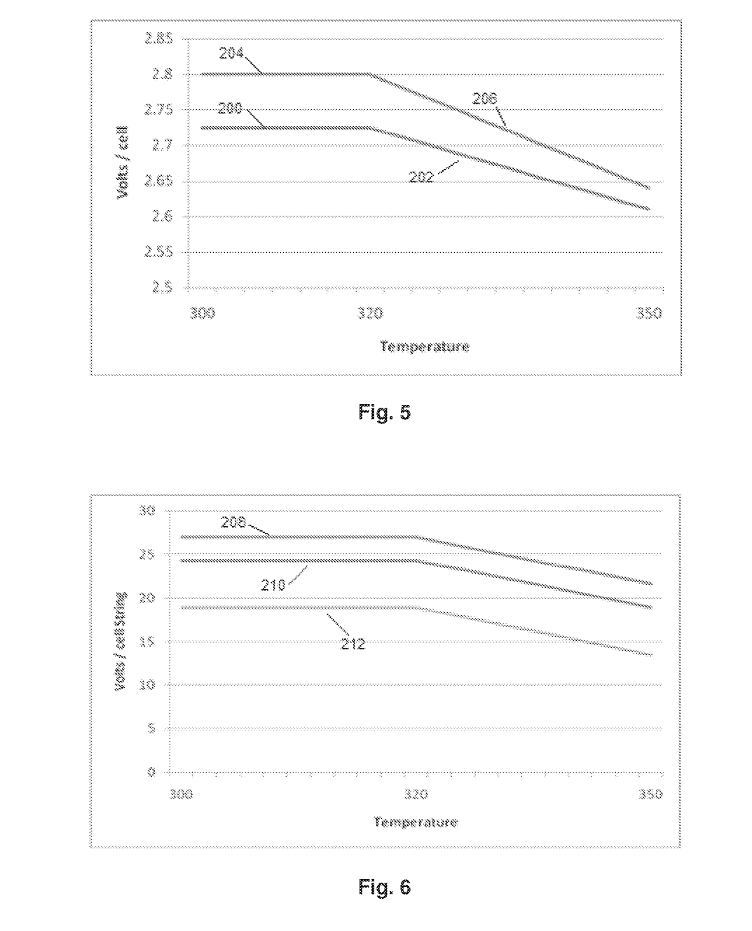

The charge regulators of the rechargeable battery limit the charge voltage and current applied to each cell string based on a determined top-of-charge voltage for each cell string. As discussed above, the top-of-charge voltage for a given cell string is determined from one or more factors, including monitored operating parameters of the electrochemical cells of the rechargeable battery. Referring now to FIG. 5, one example of determining a top-of-charge voltage, indicated as volts per cell (Volts/cell), is shown. By way of illustration, in one embodiment, a single electrochemical cell has a nominal voltage of 2,725 volts. The top-of-charge voltage for a cell string having a plurality of these electrochemical cells would be 2,725 volts per cell. If the cell string contains 10 electrochemical cells, the nominal top-of-charge voltage would be 27.25 volts. In various embodiments, however, the determined top-of-charge voltage is varied from the nominal voltage based upon at least one monitored operating parameter of the electrochemical cells or other parameters of the rechargeable battery system. In one example, the temperature of one or more of the electrochemical cells is monitored and the allowable top-of-charge voltage is reduced in response to an increased temperature of the electrochemical cells. As shown in FIG. 5, line 200 represents the determined top-of-charge voltage for an electrochemical cell over a range of operating temperatures. Line 200 reflects the nominal top-of-charge voltage assuming extended charging operations, such as greater than ten minutes. When the monitored temperature of one or more of the electrochemical cells increases above a threshold temperature, however, the determined top-of-charge is progressively reduced as illustrated by line 202. As the battery temperature rises, the efficiency of the electrochemical cells is reduced. To protect the electrochemical cells from being overcharged at elevated temperatures, it may be desired to limit the charging voltage applied to the electrochemical cells as shown by the reduced top-of-charge voltage shown by line 202. The top-of-charge can thus be determined from the monitored parameters of the electrochemical cells taking into consideration the physical and chemical makeup of the electrochemical cells and their desired operating conditions.

In another example, the top-of-charge voltage is increased from the nominal top-of-charge voltage when the charging operation is of a short duration, such as less than ten minutes, less than five minutes, or less than one minute. In some applications, such as regenerative vehicle braking systems, recharging the rechargeable battery is expected to occur for only a limited time. In such applications, the expected or actual duration of recharging may be factored into the determined top-of-charge voltage, and the top-of-charge is increased for short duration charging. As shown in FIG. 5 by line 204, when the charge duration is less than a predetermined period, such as less than ten minutes, the determined top-of-charge is increased to 2.8 volts per cell. Although over longer charging durations the increased top-of-charge voltage may be detrimental to the electrochemical cells, when the charge duration is known to be limited in nature the electrochemical cells may be configured to accommodate the increased top-of-charge voltage and increase the energy stored during the recharging period. If the recharging period extends beyond the allowable time limit, the determined top-of-charge may be reduced to the longer duration or steady state limit noted by line 200. As discussed above, as the monitored temperature of the electrochemical cells increases above a threshold, the top-of-charge voltage may be decreased as illustrated by line 206. In this manner, both the expected or actual duration of charging and the monitored cell temperature are used to determine the top-of-charge voltage for the cell string. In yet another example (not shown), the determined top-of-charge voltage is adjusted as the monitored parameters of the electrochemical cells, such as the state of charge, change during the recharging operation. Multiple parameters, such as expected charge duration, temperature and state of charge, may be used individually or in combination to determine the appropriate top-of-charge voltage for a cell string in the rechargeable battery. Similarly, other monitored parameters or characteristics of the chosen application may be utilized to determine the top-of-charge for a cell string. As will be apparent, the specific voltages discussed herein are for illustration only.

In another embodiment, the determined top-of-charge for a cell string is also determined based upon the number of failed or degraded electrochemical cells detected in a cell string. A rechargeable battery having electrochemical cells that form a substantially short circuit when in a failed state may be capable of continued operation with one or more failed electrochemical cells. In an embodiment, the determined top-of-charge voltage of a cell string is a function of the number of failed electrochemical cells, or conversely, the number of operational electrochemical cells in the cell sting. Referring to FIG. 6, line 208 illustrates the determined top-of-charge voltage for a cell string having a full complement of healthy electrochemical cells. In the example illustrated, a cell string has ten electrochemical cells each having a voltage of 2.7 volts for a determined top-of-charge voltage of 27 volts for selected operating temperatures. As previously noted, the determined top-of-charge voltage for the cell string may be reduced as the temperature of the electrochemical cells increases above a threshold, such as 320 degrees Celsius. Also illustrated in FIG. 6 is line 210 representing the determined top-of-charge voltage of the cell string with one failed electrochemical cell, and line 212 illustrating the determined top-of-charge voltage with three failed electrochemical cells. As will be apparent, other factors, such as the expected charge duration and the selection of the electrochemical cells, may influence the determination of the top-of-charge voltage for the cell string. In one embodiment, the monitoring system of a rechargeable battery includes a microprocessor or other computing device adapted to determine the top-of-charge voltage from one or more monitored parameters as well from inputs characterizing the system in which the rechargeable battery is utilized.

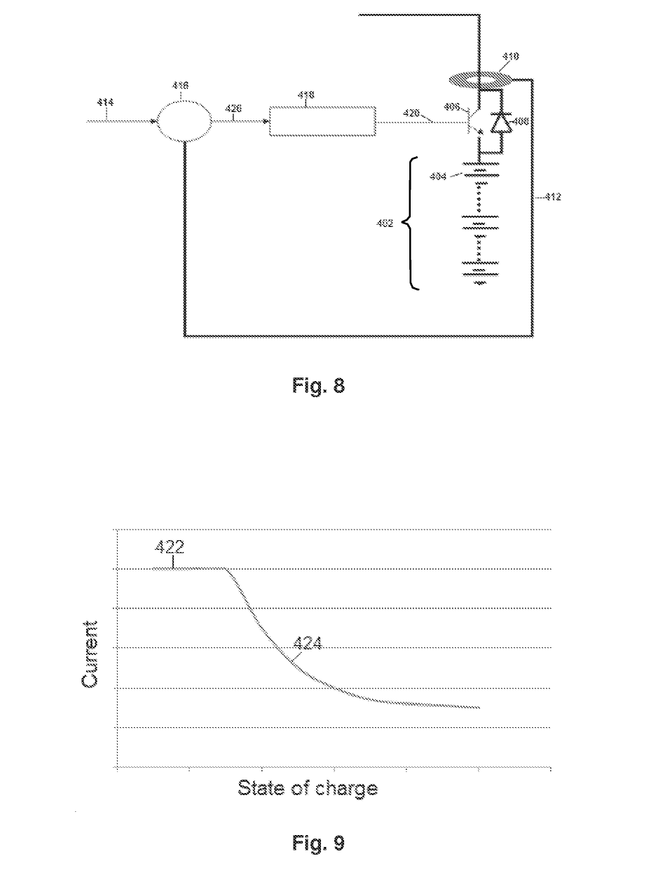

Referring now to FIGS. 8 and 9, a method of operating a rechargeable battery system is illustrated with current monitoring. As shown in FIG. 8, a cell string 402 of a rechargeable battery includes a plurality of electrochemical cells 404. A charge regulator transistor 406 is provided in series with the cell string 402 and a discharge path diode 408 is provided in parallel with the charge regulator transistor 406. The rechargeable battery includes a monitoring system having a current sensor 410 providing a current monitoring signal 412 corresponding to the charge current flowing into the cell string 402. A desired charge current signal 414 is determined from the determined top-of charge voltage for the cell string 402. The desired charge current signal 414 and the current monitoring signal 412 are compared by comparator 416 and the difference signal 426 is provided to a proportional integral controller 418 that provides a charge regulator control signal 420 to the charge regulator transistor 406. If the charge current and the desired charge current deviate from one another, the monitoring system and charge regulator operate to return the charge current to the desired charge current.

As shown in FIG. 9, the desired charge current signal 414 is determined by the state of charge of the cell string. When the state of charge of the cell string is below a determined level, the desired charge current is limited to the maximum charge current 422. In one embodiment, the maximum charge current is determined by the capacity of the cooling system of the rechargeable battery. As the state of charge of the cell string increases, a decreasing charging current 424 is provided until the cell string reaches the determined top-of-charge voltage and the charge operation is discontinued.

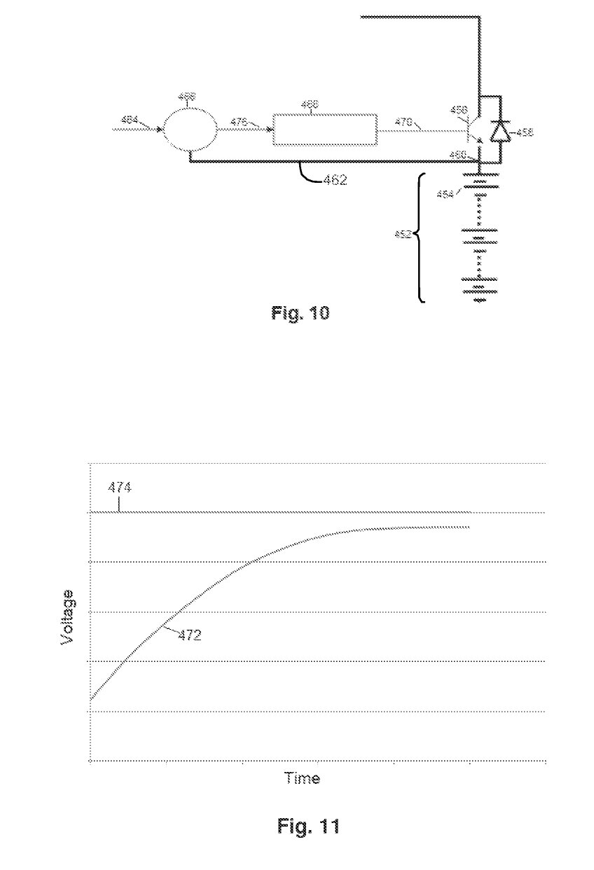

Referring now to FIGS. 10 and 11, a method of operating a rechargeable battery system is illustrated with voltage monitoring. As shown in FIG. 10, a cell string 452 of a rechargeable battery includes a plurality of electrochemical cells 454. A charge regulator transistor 456 is provided in series with the cell string 452 and a discharge path diode 458 is provided in parallel with the charge regulator transistor 456. The rechargeable battery includes a monitoring system having a voltage sensor 460 providing a voltage monitoring signal 462 corresponding to the state of charge of the cell string 452. In one embodiment, the voltage monitoring signal 462 is the voltage across the cell string. The desired top-of-charge signal 464 is determined from the determined top-of charge voltage for the cell string 452. The desired top-of-charge signal 464 and the voltage monitoring signal 462 are compared by comparator 466 and the voltage difference signal 476 is provided to a proportional integral controller 468 that provides a charge regulator control signal 470 to the charge regulator transistor 456. As the state of charge of the cell string as represented by the voltage monitoring signal 462 approaches the determined top-of charge thr the cell string, the voltage difference signal will decrease, and the monitoring system and charge regulator will cooperate to control the charge regulator transistor 456 to reduce the rate of charge until the cell string reaches the top-of-charge voltage and the charge operation is discontinued. Once the cell string has been discharged, the charging operation will repeat as described above.

As shown in FIG. 11, the desired top-of-charge signal 464 corresponds to the determined top-of-charge voltage 474 for the cell string 452. As the state of charge 472 of the cell string 452 increases the difference between the state of charge and the top-of-charge voltage 474 decreases, and the rate of charge is progressively limited. If the state of charge is sufficiently low, the rate of charge may be limited so as not to exceed a maximum power dissipation of the charge regulator. In one embodiment, the maximum power dissipation of the charge regulator is determined by the capacity of the cooling system of the rechargeable battery. As the state of charge of the cell string increases, a decreasing charging current is provided until the cell string reaches the determined top-of-charge voltage and the charge operation is discontinued.

In yet another embodiment, a rechargeable battery includes a plurality of cell strings, each cell string having a plurality of rechargeable electrochemical cells connected in series; each cell string has a respective charge regulator connected in series with the cell string, wherein the charge regulator is adapted to limit at least one of a charge voltage or a charge current applied to the cell string based on at least one first monitored parameter of the cell string; and each cell string also has a respective discharge regulator connected in series with the cell string, wherein the discharge regulator is adapted to limit at least one of a discharge voltage or a discharge current from the cell string based on the at least one first monitored parameter of the cell string or at least one second monitored parameter of the cell string. In one embodiment, the electrochemical cells form a substantially short circuit when in a fail state as previously discussed. In another embodiment, the at least one first monitored parameter of the cell string is a state of charge of the cell string. In yet another embodiment, each discharge regulator is further adapted to disconnect a given cell string from a load based upon the at least one first monitored parameter of the cell string or the at least one second monitored parameter of the cell string.

Also disclosed is a method of operating a rechargeable battery system. The method includes determining a top-of-charge voltage for each of a plurality of cell strings of a rechargeable battery, each cell string having a plurality of electrochemical cells and a charge regulator and a discharge regulator in series with the electrochemical cells, wherein the top-of-charge voltage is determined based on at least one first monitored parameter of the cell string. The method also includes operating the charge regulator of each cell string to limit at least one of a charge voltage or a charge current applied to the cell string based on the determined top-of-charge voltage for the cell string; and operating the discharge regulator of each cell string to limit at least one of a discharge voltage or a discharge current from the cell string based upon the at least one first monitored parameter of the cell string or based upon at least one second monitored parameter of the cell string. In one embodiment, the method also includes operating the discharge voltage regulator of each cell string to limit at least one of a discharge voltage or a discharge current from the cell string to supply a substantially uniform output voltage to a load. In another embodiment, the method includes determining the top-of-charge voltage for each of the cell strings based upon a detected number of operational electrochemical cells in the cell string.

In another embodiment, the method of operating a rechargeable battery system includes maintaining the discharge regulator of each cell string in a conductive state while the cell string is charging. In one embodiment, the method of operating a rechargeable battery system includes operating a discharge regulator to disconnect a cell string from a load when the state of charge of the cell string is less than a threshold. In another embodiment, the method of operating a rechargeable battery system includes operating the charge regulator of each cell string to disconnect the cell string from a source when the state of charge of the cell string reaches the determined top-of-charge for the cell string. In yet another embodiment, the determined top-of-charge voltage for at least one of the plurality of cell strings is different than the determined top-of-charge voltage for a different one of the plurality of cell strings. In yet another embodiment, the method of operating a rechargeable battery system includes operating the charge regulators to reduce fluctuation in a source voltage to provide a substantially constant charge voltage to each cell string.

The rechargeable battery system and method of operating a rechargeable battery system presently disclosed provides for active control of cell strings. By actively controlling the cell strings with the charge regulator and discharge regulator, the rechargeable battery may be utilized with a wide variety of sources and loads while improving the efficiency of the rechargeable battery system operation.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. A rechargeable battery comprising:
a plurality of cell strings, each cell string having a plurality of rechargeable electrochemical cells connected in series; and
a plurality of charge regulators, each charge regulator connected in series with one of the plurality of cell strings, wherein each charge regulator is adapted to limit at least one of a charge voltage or a charge current applied to the cell string based on a determined top-of-charge voltage for each cell string.

2. The rechargeable battery as claimed in claim 1, wherein the rechargeable battery further comprises:
a monitoring system configured, for each cell string, to sense at least one operating parameter of the cell string and determine the top-of-charge voltage for the cell string; and
wherein each one of the plurality of charge regulators includes a charge voltage controller in communication with the monitoring system and configured to limit at least one of the charge voltage or the charge current applied to the cell string based on the determined top-of-charge voltage for the cell string determined by the monitoring system.

3. The rechargeable battery as claimed in claim 2, wherein the at least one operating parameter of the cell string is selected from the group consisting of: a cell string voltage, a cell string current, and combinations thereof.

4. The rechargeable battery as claimed in claim 2, wherein the at least one operating parameter of the cell string is selected from the group consisting of: a number of failed electrochemical cells in the cell string, a number of operational electrochemical cells in the cell string, astute of charge of the cell string, a temperature of at least one electrochemical cell in the cell string, a duration of charge for the cell string, and combinations thereof.

5. The rechargeable battery as claimed in claim 2, wherein the rechargeable battery further comprises:
a proportional integral controller providing a charge regulator control signal for each cell string determined from a state of charge of the cell string and the determined top-of-charge voltage of the cell string.

6. The rechargeable battery as claimed in claim 1, wherein each charge regulator comprises a transistor.

7. The rechargeable battery as claimed in claim 1, further comprising a plurality of discharge paths, each discharge path connected in parallel with one of the plurality of the charge regulators and configured to pass discharge current from a given cell string to a load.

8. The rechargeable battery as claimed in claim 7, wherein each discharge path comprises a diode.

9. The rechargeable battery as claimed in claim 1, wherein the electrochemical cells are sodium-metal-halide cells.

10. The rechargeable battery as claimed in claim 1, wherein the electrochemical cells form a substantially short circuit when in a failed state.

11. The rechargeable battery of claim 1, further comprising:
a plurality of discharge regulators, each discharge regulator connected in series with one of the plurality of cell strings, wherein each discharge regulator is adapted to limit at least one of a discharge voltage or a discharge current from a given cell string based upon at least one monitored parameter of the cell string.

12. The rechargeable battery as claimed in claim 11, wherein the plurality of discharge regulators cooperate to apply a substantially uniform output voltage to a load.

13. The rechargeable battery as claimed in claim 11, wherein each discharge regulator is further adapted to disconnect a given cell string from a load based upon the at least one monitored parameter of the cell string.

14. The rechargeable battery as claimed in claim 11, wherein the rechargeable battery further comprises:
a monitoring system configured to sense the at least one monitored parameter of the cell string, the at least one monitored parameter comprising at least one operating parameter of the cell string; and
wherein each of the plurality of discharge regulators includes a discharge voltage controller in communication with the monitoring system configured to limit the at least one of the discharge voltage or the discharge current from a given cell string based on the at least on operating parameter of the cell string.

15. The rechargeable battery as claimed in claim 14, wherein the at least one operating parameter of the cell string is selected from the group consisting of: a cell string voltage, a cell string current, and combinations thereof.

16. The rechargeable battery as claimed in claim 14, wherein the at least one operating parameter of the cell string is selected from the group consisting of: a number of failed electrochemical cells in the cell string, a state of charge of the cell string, a number of operational electrochemical cells in the cell string, a temperature of at least one electrochemical cell in the cell string, a duration of charge for the cell string, and combinations thereof.

17. The rechargeable battery as claimed in claim 11, wherein each discharge regulator comprises a transistor.

18. The rechargeable battery as claimed in claim 11, further comprising a plurality of charge paths, each charge path connected in parallel with one of the plurality of the discharge regulators configured to pass charge current from a source to a given cell string.

19. The rechargeable battery as claimed in claim 18, wherein each charge path comprises a diode.

20. A method of operating a rechargeable battery system comprising:
determining a top-of-charge voltage for each of a plurality of cell strings of a rechargeable battery, each cell string having a plurality of electrochemical cells and a charge regulator and a discharge regulator in series with the electrochemical cells, wherein the top-of-charge voltage is determined based on at least one first monitored parameter of the cell string;
operating the charge regulator of each cell string to limit at least one of a charge voltage or a charge current applied to the cell string based on the determined top-of-charge voltage for the cell string; and
operating the discharge regulator of each cell string to limit at least one of a discharge voltage or a discharge current from the cell string based upon the at least one first monitored parameter of the cell string or based upon at least one second monitored parameter of the cell string.

21. The method as claimed in claim 20, further comprising:
determining the top-of-charge voltage for each of the cell strings based upon a detected number of operational electrochemical cells in the cell string.

22. The method as claimed in claim 20, further comprising:
maintaining the discharge regulator of each cell string in a conductive state while the cell string is charging.

23. The method as claimed in claim 20, further comprising:
for each of one or more of the cell strings, operating the discharge regulator of the cell string to disconnect the cell string from a load when a state of charge of the cell string is less than a threshold.

24. The method as claimed in claim 20, further comprising:
operating the charge regulator of each cell string to disconnect the cell string from a source when a state of charge of the cell string reaches the determined top-of-charge voltage for the cell string.

25. The method as claimed in claim 20, wherein the determined top-of-charge voltage for at least one of the plurality of cell strings is different than the determined top-of-charge voltage for a different one of the plurality of cell strings.

26. The method as claimed in claim 20, further comprising:
operating the charge regulators to reduce fluctuation in a source voltage to provide a substantially constant charge voltage to each cell string.

27. A rechargeable battery comprising:
a plurality of cell strings, each cell string having a plurality of rechargeable electrochemical cells connected in series; and
for each cell string:
a respective charge regulator connected in series with the cell string, wherein the charge regulator is adapted to limit at least one of a charge voltage or a charge current applied to the cell string based on at least one first monitored parameter of the cell string; and
a respective discharge regulator connected in series with the cell string, wherein the discharge regulator is adapted to limit at least one of a discharge voltage or a discharge current from the cell string based on the at least one first monitored parameter of the cell string or at least one second monitored parameter of the cell string.

28. The rechargeable battery as claimed in claim 27, wherein the at least one first monitored parameter of the cell string comprises a state of charge of the cell string.

29. The rechargeable battery as claimed in claim 27, wherein the electrochemical cells form a substantially short circuit when in a failed state.

30. The rechargeable battery as claimed in claim 27, wherein each discharge regulator is further adapted to disconnect a given cell string from a load based upon the at least one first monitored parameter of the cell string or the at least one second monitored parameter of the cell string.
